(19) United States
(12) Patent Application Publication
(10) Pub. No.: US 2005/0017405 A1
(43) Pub. Date: Jan. 27, 2005

(54) Method of manufacturing molded article with decorative pattern

(76) Inventors: Charles Leu, Fremont, CA (US); Ga-Lane Chen, Fremont, CA (US); Tai-Cherng Yu, Tu-chen (TW); Li-Li Li, Shenzhen (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/899,535

(22) Filed: Jul. 26, 2004

(30) Foreign Application Priority Data
Jul. 25, 2003 (TW) 92120355

(51) Int. Cl. B29C 45/16

(52) U.S. Cl. 264/255; 264/328.1

(57) ABSTRACT

A method of manufacturing a molded article with a decorative pattern thereon, includes the steps of: step (10), preparing a mold and a mask with a predetermined pattern thereon; step (11), mounting the mask in the mold; step (12), spraying ink or paint onto the mask to form a decorative pattern thereon; step (13), injecting a molten plastic into the mold to form a molded article body; and step (14), simultaneously transferring the decorative pattern from the mask onto the molded article body, and thus forming a molded article with a decorative pattern thereon.

### BACKGROUND OF THE INVENTION

1. Field of the Invention

The present invention relates generally to a method of manufacturing a molded article, and particularly to manufacturing a molded article with a decorative pattern thereon.

2. Description of Related Art

Nowadays, many methods are adopted for decorating articles, for instance, using a transferring process to transfer a decorative film to a body of an article during injection. Such a method is disclosed in U.S. Pat. No. 6,245,182. The method comprises the steps of: placing a transfer material in a mold with a protecting printed layer thereof facing inside; injecting a resin into a cavity for filling, molding and simultaneously adhering a protecting printed layer of the transfer material to a surface of the molded resin; releasing a substrate sheet; and irradiating with an active energy ray. However, this method needs high precision of the mold for positioning and cutting the transfer material, and needs additional steps, such as cutting, thereby being high cost and complicated.

Therefore, an improved method of manufacturing a molded article with a decorative pattern thereon is desired which overcomes the disadvantages of the prior art.

### SUMMARY OF THE INVENTION

A main object of the present invention is to provide a relative simple and lower-cost method to produce a molded article with a decorative pattern thereon.

A method of manufacturing a molded article with a decorative pattern thereon, comprises the steps of: preparing a mold and a mask with a predetermined pattern thereon; mounting the mask in the mold; spraying ink or paint onto the mask to form a decorative pattern thereon; injecting a molten plastic into the mold to form a molded article body; simultaneously transferring the decorative pattern from the mask onto the molded article body, and thus forming a molded article with a decorative pattern thereon.

Other objects, advantages and novel features of the invention will become more apparent from the following detailed description of a preferred embodiment thereof when taken in conjunction with the accompanying drawings, wherein:

### BRIEF DESCRIPTION OF THE DRAWINGS

FIG. 1 is a flow chart of a method for manufacturing a molded article with a decorative pattern thereon in accordance with a preferred embodiment of the present invention; and

FIG. 2 is a flow chart of a method for manufacturing a molded article with a decorative pattern thereon in accordance with another embodiment of the present invention.

### DETAILED DESCRIPTION OF THE INVENTION

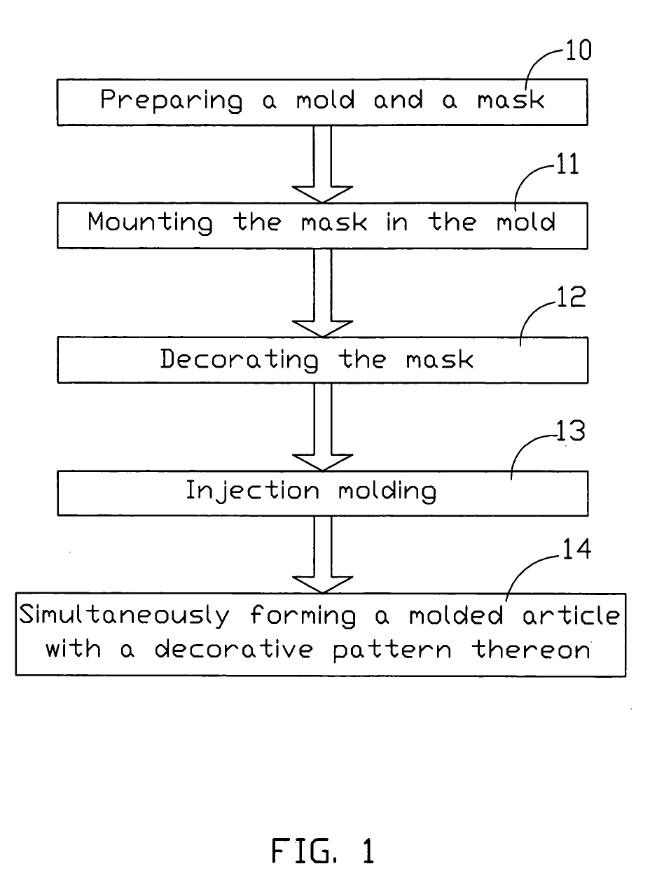

Referring now to the drawings in detail, FIG. 1 shows a method of manufacturing a molded article with a decorative pattern thereon according to a first embodiment of the present invention. The method comprises the steps of: step 10, preparing a mold and a mask; step 11, mounting the mask in the mold; step 12, decorating the mask; step 13, injection molding; and step 14, forming a molded article with a decorative pattern thereon.

In step 10, the mold is made from common materials and is manufactured using a well known method in the art. The mold includes a female mold and a male mold. The mask is made from metal, such as aluminum, copper, iron or steel, or a metal alloy. The mask has a predetermined pattern formed on its surface.

In step 11, the mask 10 is mounted in the mold with a surface without the pattern fitting against an inner wall of the female mold.

In step 12, ink or paint is sprayed or coated onto the mask on the pattern thereof, so that a decorative pattern is formed on the mask. After that, the mold is closed for injection.

In step 13, a molten plastic is injected into the mold to form an article body, and an outer surface of the article body contacts the mask on its surface with the decorative pattern thereon. Regarding the plastic, though not limited to, there can be exemplified in particular a resin such as a polyvinyl chloride resin, a polyethylene terephthalate resin, an acrylonitrile butadiene styrene resin, a polycarbonate resin, a polyamide imides resin, a liquid crystal polymer, a polyetherimide resin, a polyphenylene sulfide resin, a polysulphone resin, a polystyrene resin, a glycol-modified polyester resin, a polypropylene resin, a polymethyl methacrylate resin, and so on.

In step 14, the decorative pattern is transferred from the mask to the article body, so that a molded article with a decorative pattern thereon is formed at the same time of injection molding of the article.

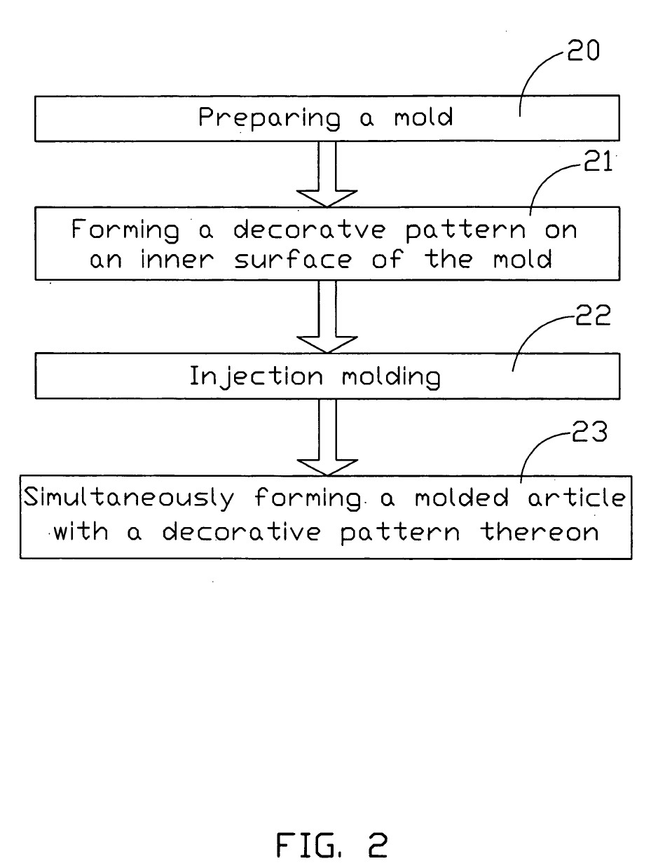

In another embodiment, as shown in FIG. 2, the method comprises the steps of: step 20, preparing a mold; step 21, forming a decorative pattern on an inner surface of the mold; step 22, injection molding; and step 23, simultaneously forming a molded article with a decorative pattern thereon.

In step 20, the mold is made from a metal compound powder, such as Zirconium dioxide (ZrO₂), Aluminum oxide (Al₂O₃), Tungsten carbide (WC), and Titanium boron (TiB), and is manufactured using a sinter process, so that the mold possess a loose state and forms multi-pores in an inner surface thereof. Furthermore, the mold forms a predetermined pattern on its inner surface.

In step 21, ink or paint is sprayed or coated onto the inner surface of the mold on the pattern thereof, so that a decorative pattern is formed on the inner surface of the mold. After that, the mold is closed for injection.

In step 22, a molten plastic corresponding to the first embodiment is injected into the mold and forms a molded article body with an outer surface thereof contacting the patterned inner surface of the mold. Then, a predetermined pressure is exerted onto the mold, so that the decorative pattern is transferred from the inner surface of the mold onto the molded article body in step 23, therefore, a molded article with a decorative pattern thereon is formed. Step 22 and step 23 can be simultaneously finished.

It is understood that the invention may be embodied in other forms without departing from the spirit thereof. Thus, the present examples and embodiments are to be considered in all respects as illustrative and not restrictive, and the invention is not to be limited to the details given herein.

1. A method of manufacturing a molded article with a decorative pattern thereon comprising the steps of:
preparing a mold with a predetermined pattern on an inner surface thereof;
decorating the pattern on the inner surface of the mold;
injection molding; and
simultaneously forming a molded article with a decorative pattern thereon.

2. The method as claimed in claim 1, wherein, in the step of preparing a mold with a predetermined pattern on an inner surface thereof, the mold is formed to have the inner surface thereof in a loose state with multi-pores therein.

3. The method as claimed in claim 2, wherein the mold is made from a metal compound powder and is manufactured using a sinter process.

4. The method as claimed in claim 3, wherein the metal compound is selected from the group consisted of Zirconium dioxide, Aluminum oxide, Tungsten carbide, and Titanium boron.

5. The method as claimed in claim 1, wherein, in the step of decorating the pattern on the inner surface of the mold, ink or paint is sprayed or coated onto the pattern.

6. The method as claimed in claim 1, wherein, in the step of forming a molded article with a decorative pattern thereon, the decorated pattern is transferred from the inner surface of the mold onto the molded article by way of exerting a predetermined pressure onto the mold.

7. A method of manufacturing a molded article with a decorative pattern thereon comprising the steps of:
preparing a mold and a mask, the mask having a predetermined pattern on its surface;
decorating the pattern of the mask;
injection molding; and
simultaneously forming a molded article with a decorative pattern thereon.

8. The method as claimed in claim 7, wherein, in the step of preparing a mold and a mask, the mask is made from metal or metal alloy.

9. The method as claimed in claim 7, further comprising a step of mounting the mask in the mold with a surface without the pattern against an inner surface of a female mold of the mold after the step of preparing a mold and a mask and before the step of decorating the pattern of the mask.

10. The method as claimed in claim 7, further comprising a step of mounting the mask in the mold with a surface without the pattern against an inner surface of a female mold of the mold after the step of decorating the pattern of the mask and before the step of injection molding.

11. The method as claimed in claim 7, wherein, in the step of decorating the pattern of the mask, ink or paint is sprayed or coated onto the pattern.

12. The method as claimed in claim 7, wherein, in the step of forming a molded article with a decorative pattern thereon, the decorated pattern is transferred from the mask onto the molded article at the same time of injection molding of the molded article.
